(19) United States
(12) Patent Application Publication
(10) Pub. No.: US 2025/0183527 A1
(43) Pub. Date: Jun. 5, 2025

(54) ELECTROMAGNETIC COUPLING STRUCTURE FOR DETACHABLE WIRELESS ANTENNA FEED

(71) Applicants: Eduardo Antonio Rojas, Port Orange, FL (US); Amanda Michelle Schrand, Destin, FL (US); Edwin Ray Elston, Eglin AFB, FL (US); Clayton Garrett Neff, Casselberry, FL (US); Blake A. Roberts, South Daytona, FL (US)

(72) Inventors: Eduardo Antonio Rojas, Port Orange, FL (US); Amanda Michelle Schrand, Destin, FL (US); Edwin Ray Elston, Eglin AFB, FL (US); Clayton Garrett Neff, Casselberry, FL (US); Blake A. Roberts, South Daytona, FL (US)

(21) Appl. No.: 18/968,350

(22) Filed: Dec. 4, 2024

Related U.S. Application Data
(60) Provisional application No. 63/606,430, filed on Dec. 5, 2023.

(51) Int. Cl. H01Q 1/50; H01P 5/08; H01Q 1/42

(52) U.S. Cl. CPC H01Q 1/50; H01P 5/08; H01Q 1/42

(57) ABSTRACT

Antenna radiating elements are generally coupled with an antenna port to feed such radiating elements. An electromagnetic coupling structure can be used, without requiring conductive interconnects between the antenna radiating elements and the antenna port. A radiating structure fed by an electromagnetic coupling structure can be referred to as a “wireless feed.” Such a feed configuration can be detachable, such as where the coupling structure can be mechanically separated into multiple portions to provide detachability, without requiring manipulation or detachment of conductive interconnects. Fabrication of one or more portions of a wireless feed structure can include use of an additive manufacturing approach.

### CLAIM OF PRIORITY

This patent application claims the benefit of priority of Rojas et al., U.S. Provisional Patent Application No. 63/606,430, titled “ELECTROMAGNETIC COUPLING STRUCTURE FOR DETACHABLE WIRELESS ANTENNA FEED,” filed on Dec. 5, 2023 (Attorney Docket No. 4568.020PRV), which is hereby incorporated by reference herein in its entirety.

### STATEMENT REGARDING FEDERALLY SPONSORED RESEARCH OR DEVELOPMENT

This invention was made with government support under award number 1944599 awarded by the National Science Foundation and under award numbers FA8651-20-1-0004 and FA8651-23-F-A029 by the United States Air Force. The government has certain rights in the invention.

### FIELD OF THE DISCLOSURE

This document pertains generally, but not by way of limitation, to antenna feed structures and related wireless systems, and more particularly to wirelessly coupled antenna feed structures that can conform to a three-dimensional surface, such as can be fabricated using an additive manufacturing approach.

### BACKGROUND

An antenna can be arranged to conform to a curved surface or be included as a portion of such as surface, such as a portion of a wing or other structure (e.g., a radome). An antenna port is generally located on or within an inner portion of the radome or other structure, providing an electrical connection from the inner portion to an outer radiating portion, using one or more interconnects. For example, this can be accomplished using wires or other conductors that penetrate from an exterior of a radome to an interior, such as through metalized holes.

### SUMMARY OF THE DISCLOSURE

Use of conductive interconnects between internal and external portions of a wing or other structure can increase vulnerability to electrical and mechanical failures, such as when the structure is subject to external forces or thermal cycling, as illustrative examples. In some conformal antenna configurations, use of fixed conductive electrical interconnects between a transmitter or receiver and a radiating element may inhibit detachment or can make such detachment cumbersome (e.g., involving connecting or disconnecting connectors or involving use of specialized tools). In various applications, a detachable configuration is desired, such as where detachment of a radiating element (or assembly) from a feed structure is supported.

The present inventors have recognized, among other things, that an electromagnetic coupling structure can be used, without requiring conductive interconnects between antenna radiating elements and an antenna port to feed such radiating elements. For example, the present subject matter can include a radiating structure fed by an electromagnetic coupling structure, which can be referred to as a “wireless feed.” Such a feed configuration can be detachable (e.g., the coupling structure can be mechanically separated into multiple portions to provide detachability), without requiring manipulation or detachment of conductive interconnects. Use of a detachable electromagnetic coupling structure facilitates applications where a radome or other structure can be removable from another assembly.

Conformal antennas can be fabricated to conform to curved structures such as wings or other shapes using an additive manufacturing approach. For example, an unmanned aerial vehicle (UAV) airfoil can be used as an aerodynamic surface and can support or house a conformal antenna, providing a “functional” surface. Additive manufacturing approaches can be used at least in part to fabricate elements of such functional surfaces. For example, additive manufacturing approaches can provide attributes such as specified radio frequency or microwave frequency performance (e.g., “low” loss for applications into the gigahertz (GHz) or tens of GHz range of frequencies) or survivability in high-temperature environments, or combinations thereof. The present inventors have also recognized, among other things, that a portion or an entirety of an electromagnetic coupling structure can be fabricated using such an additive manufacturing approach. The examples described herein can also provide a detachability aspect, such as allowing removal from or attachment of an antenna structure to another structure, including severing or establishing an electrical interconnection between the antenna structure and a transmitter or receiver (or transceiver), without requiring a conductive interconnection.

In an example, an electronic assembly for wirelessly coupling a signal between transmission line structures can include a first portion comprising a first conductive layer and a first dielectric layer, the first conductive layer defining a first stub, a second portion comprising a second conductive layer and a second dielectric layer, the second conductive layer defining a second stub, a third conductive layer defining a slot overlapping with the first stub and the second stub. The first portion can include a first reference plane layer and a first dielectric core layer, the first conductive layer and the first reference plane layer clad the first dielectric core layer, and the first dielectric layer can be located on a surface of the first conductive layer opposite the first dielectric core layer. The layers mentioned above can be conformal to a curved surface, such as a three-dimensional surface.

In an example, an antenna and feed structure can include an antenna port, a wireless electromagnetic coupling structure comprising a line-slot-line transition to couple a signal from or to the antenna port wirelessly through a conductive layer comprising a slot, and a radiating element configured to radiate the signal that is wirelessly coupled through the slot, or to receive incoming radiated energy and provide the signal that is wirelessly coupled through the slot as a received signal. For example, the dielectric material can define a radome.

In an example, a method for fabricating an electronic assembly for wirelessly coupling a signal between transmission line structures can include forming a first portion comprising at a first conductive layer and a first dielectric layer, the first conductive layer defining a first stub, forming a second portion comprising a second conductive layer and a second dielectric layer, the second conductive layer defining a a second stub, and forming a third conductive layer defining a slot overlapping with the first stub and the second stub.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A shows a side view of an electromagnetic coupling structure that can be used to provide a wireless feed for an antenna, in an assembled configuration.

FIG. 1B shows a side view of the electromagnetic coupling structure of FIG. 1A, in a separated or detached configuration.

FIG. 2A shows a representation of a portion of a structure, such as a radome, comprising a radiating element on an outer surface of the structure that is coupled to a port by a detachable inner structure.

FIG. 2B shows the structure of FIG. 2A in a separated or detached configuration.

FIG. 3A shows an illustrative example of a layer stack-up of dielectric and conductive layers that can be used to provide an electromagnetic coupling structure, such as corresponding to the illustrative examples of FIG. 3B and FIG. 3C.

FIG. 3B shows a three-dimensional view of an illustrative example comprising a wireless feed structure comprising a stack of dielectric and conductive layers that form a microstrip-slot-microstrip (MSM) transition.

FIG. 3C shows another view of a portion of the illustrative example of FIG. 3B, further illustrating a slot and stub configuration of the microstrip-slot-microstrip (MSM) transition.

FIG. 4A shows an image of an illustrative example comprising a microstrip-slot-microstrip (MSM) transition comprising the configuration shown in FIG. 3A, FIG. 3B, and FIG. 3C, manufactured using a Rogers 4003C material.

FIG. 4B shows an image of an illustrative example comprising a microstrip-slot-microstrip (MSM) transition comprising the configuration shown in FIG. 3A, FIG. 3B, and FIG. 3C, fabricated using an additive manufacturing approach.

FIG. 5A shows S-Parameters as simulated and measured for the illustrative example shown in FIG. 4A fabricated using Rogers 4003C.

FIG. 5B shows S-Parameters simulated and measured for the example shown in FIG. 4B fabricated using the additive manufacturing approach.

FIG. 6 shows an illustrative example of a technique, such as a method, for fabricating an electromagnetic coupling structure.

### DETAILED DESCRIPTION

An electromagnetic coupling structure can be used to couple a signal to or from a radiating structure. Such an electromagnetic coupling structure can provide a wireless feed, not requiring conductive interconnects between antenna radiating elements and an antenna port used to feed such radiating elements. The electromagnetic coupling structure can include a multi-layer structure having at least one dielectric layer. The multi-layer structure can be arranged to separate into respective portions, providing detachability.

When the structure is assembled, the structure can convey a signal between a transmission line (such as leading to a transmitter or receiver), such as within a radome or airfoil, for example, and an exterior transmission line (feeding an antenna structure), or vice versa. Energy transfer can be achieved by employing a mix of electrical and magnetic coupling in the multilayer geometry.

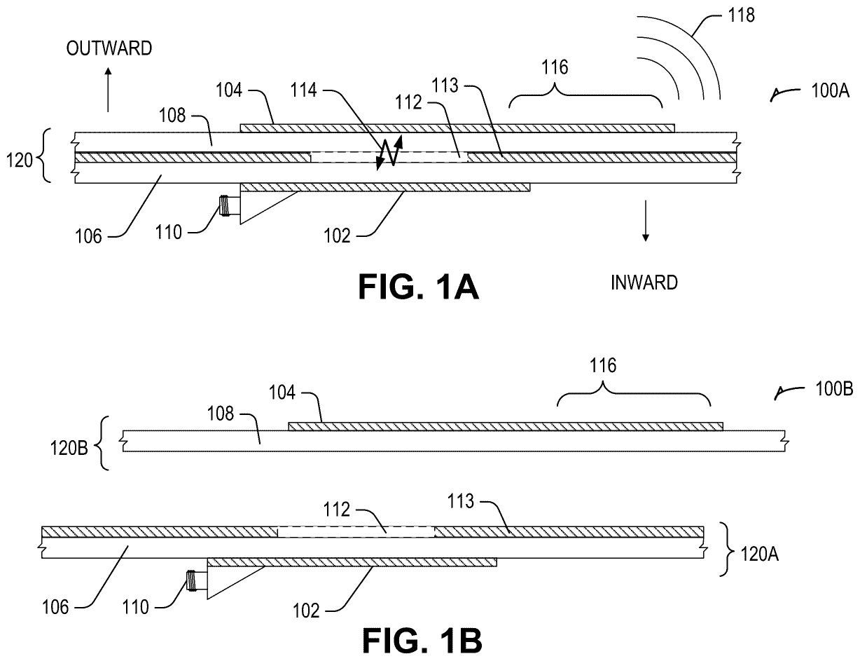

FIG. 1A shows a side view of an electromagnetic coupling structure 120 that can be used to provide a wireless feed for an antenna, in an assembled configuration 100A. As an illustration, an input port 110 (e.g., provided using a coaxial input or a transmission line structure) can be used to couple a signal to an assembly comprising a first conductive structure 102 (e.g., a single-layer or multi-layer structure, for example comprising a planar transmission line such as a microstrip structure as shown and described in other examples herein, or another structure such as a stripline or coplanar waveguide). The first conductive structure 102 can be located within a portion of a radome or airfoil, such as facing inward. Such a radome or airfoil can form a portion of a vehicle or projectile, as illustrative examples. The first conductive structure 102 can be mechanically attached to a first dielectric 106, such as a portion of a multi-layer printed circuit assembly or other dielectric material.

The electromagnetic coupling structure 120 can include a second dielectric 108, such as forming an outer portion of a radome or airfoil, such as facing outward. The second dielectric 108 can support or can otherwise be mechanically attached to a second conductive structure 104. Similar to the first conductive structure 102, the second conductive structure can include a single conductive layer or multiple layers to provide a transmission line structure. A signal 114 coupled to the first conductive structure 102 can be electromagnetically (and, accordingly, wirelessly) coupled to or from the second conductive structure 104 through a slot 112 defined by another conductive layer 113. The second conductive structure 104 can feed a radiating element 116 (e.g., a patch or other structure) to radiate or receive a signal 118, such as where the radiating element is formed using the second conductive structure 104, or the second conductive structure 104 can include a transmission line and other interconnections to couple a signal to a radiating element located elsewhere.

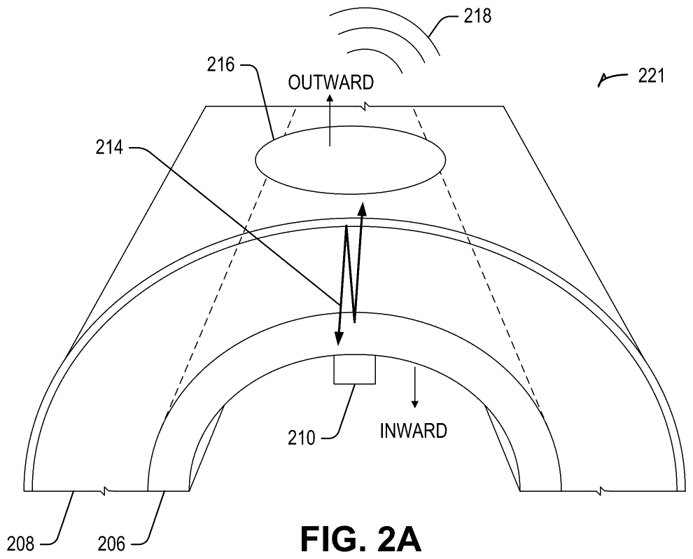

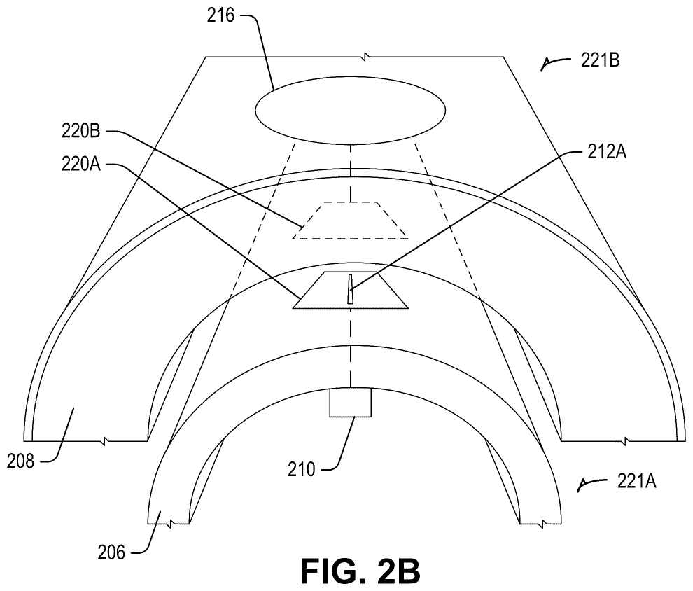

FIG. 1B shows a side view of the electromagnetic coupling structure 120 of FIG. 1A, in a separated or detached configuration 100B, such as where a first portion 120A comprising the input port 110, the first conductive structure 102, the first dielectric 106, and the conductive layer 113 is mechanically separated from a second portion 120B comprising the second dielectric 108, the second conductive structure 104, and the radiating element 116. For example, if a modular configuration as shown in FIG. 1B is used, the second portion 120B can be mated with the first portion 120A without requiring specialized tooling or conductive interconnection between the first portion 120A and the second portion 120B. The layers defining the first portion 120A and the second portion 120B are merely illustrative, and other configurations can be used the separate at a different location in the stack of layers. As shown and described in other examples herein, the first dielectric 106 can include a base or interior portion of a structure and the second dielectric 108 can include outer or removable portion of a structure, such as shown in the illustrations of FIG. 2A and FIG. 2B.

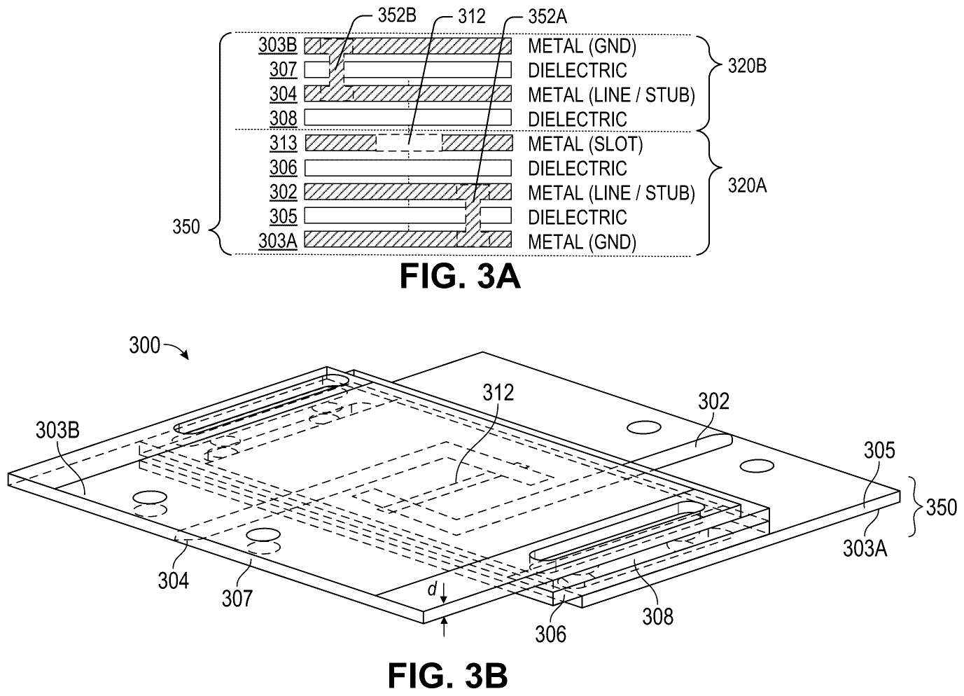

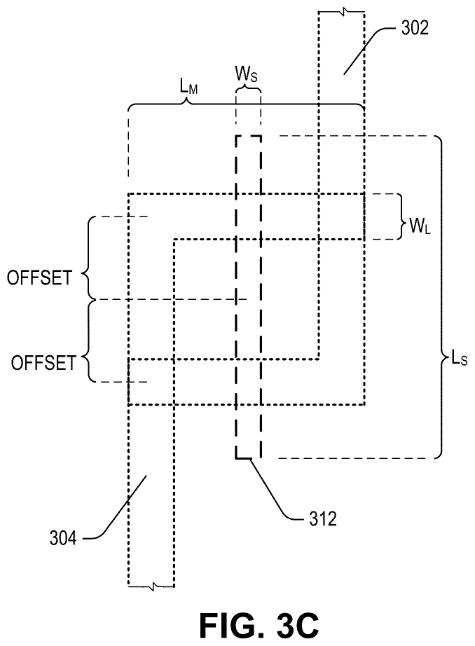

Generally, as described herein a multi-layer stack of conductive and dielectric layers can be used to couple energy from one transmission line structure to another. The stack of materials can be arranged so that one portion can be detached from the other portion. FIG. 2A shows a representation of a portion of a structure 221, such as a radome, comprising a radiating element 216 on an outer surface of the structure 221 that is coupled to a port 210 by a detachable inner structure. As shown in FIG. 2A, the structure 221 can be defined by an outer wall 208 and an inner wall 206. A multi-layer electromagnetic coupling structure (e.g., as shown in FIG. 1A, FIG. 1B, FIG. 3A, FIG. 3B, or FIG. 3C) can be used to wirelessly couple a signal 214 between the port 210 and the radiating element 216 to produce a radiated signal 218 (or, by reciprocity, to receive incoming radiated energy). The inner wall 206 can form a portion of an assembly that is detachable from the outer wall 208.

As an illustration, FIG. 2B shows the structure of FIG. 2A in a separated or detached configuration, where FIG. 2B shows a first portion 221A separated from a second portion 221B. The first portion 221A is shown including the inner wall 206 and port 210, and a first portion of a wireless electromagnetic coupling structure 220A (such as having a slot 212 as shown and described elsewhere herein). The second portion 221B is shown including the radiating element 216 and a second portion of the wireless electromagnetic coupling structure 220B. As shown in this example, the first portion 221A can be a detachable inner structure having a cylindrical or conic profile that mates with a corresponding aperture in an outer structure defined by the second portion 221B. The profiles of the first portion 221A and the second portion 221B can include a key or other alignment feature to align the first portion of the wireless electromagnetic coupling structure 220A and the second portion of the wireless electromagnetic coupling structure 220B. When the first portion of the wireless electromagnetic coupling structure 220A is mated and aligned with the second portion of the wireless electromagnetic coupling structure 220B, such as anchored to each other, a signal can be wirelessly coupled between the first portion 221A of the assembly and the second portion 221B of the assembly (as shown in FIG. 2A in the mated configuration).

FIG. 3A shows an illustrative example of a layer stack-up 350 of dielectric and conductive layers (e.g., four dielectric and five conductive metal layers) that can be used to provide an electromagnetic coupling structure, such as corresponding to the illustrative examples of FIG. 3B and FIG. 3C. The layer stack-up 350 shown in FIG. 3A can be separated into groups of layers, such as comprising two separate planar assemblies, respectively comprising multiple layers. For example, a transmission line structure can be formed by a group of layers, such as layer 303A (metal), a first core layer 305 (dielectric), and layer 302 (metal), forming a metal-dielectric-metal stack. A dielectric layer 306 can be mechanically attached to the metal-dielectric-metal stack on a surface of the layer 302 opposite the first core layer 305. This assembly 320A can be mated (e.g., aligned with and attached to) a corresponding assembly 320B, comprising a dielectric layer 308, a layer 304 (metal), a second dielectric core layer 307, and layer 303B (metal). For the microstrip and stub configuration shown in FIG. 3B and FIG. 3C, the layers 303A and 303B can be define conductive reference planes (e.g., ground layers), and the layers 302 and 304 can define respective microstrip line and stub structures. The assembly 320A can include a slot 312 in a metal layer 313 for coupling, such as a slot 312 having a configuration shown and described below in relation to FIG. 3B and FIG. 3C. While a signal can be wirelessly coupled between the assembly 320A and the corresponding assembly 320B using the slot 312, in other locations, conductive interconnections such as via structures 352A or 352B can be included within the respective assembly 320A or corresponding assembly 320B.

FIG. 3B shows a three-dimensional view of an illustrative example 300 comprising a wireless feed structure comprising a stack 350 of dielectric and conductive layers that form line-slot-line transition (e.g., a microstrip-slot-microstrip (MSM) transition). A first transmission line structure can be formed by a combination of a trace in a conductive layer 302 and a conductive plane formed in another conductive layer 303A, such as cladding a first core dielectric layer 305. Similarly, a second transmission line structure can be formed by a combination of a trace in a conductive layer 304 and a conductive plane formed in another conductive layer 303B, such as cladding a second core dielectric layer 307. The first and second transmission line structures can terminate in respective stubs, with wireless coupling occurring through a cavity (e.g., slot 312) located on a conductive layer between one or more intermediate layers (e.g., between dielectric layers 306 and 308 as shown in FIG. 3A, FIG. 3B, and FIG. 3C).

FIG. 3C shows another view of a portion of the illustrative example of FIG. 3B, further illustrating a slot and stub configuration of the microstrip-slot-microstrip (MSM) transition. A conductive layer 302 defines a microstrip trace terminating in an L-shaped open-ended stub, and a corresponding conductive layer 304 defines another microstrip trace terminating in another L-shaped open-ended stub. The layer 302 and layer 304 are separated by at least one dielectric layer (e.g., a substrate material or laminate suitable for microwave frequencies in range of one to ten gigahertz (GHz)), and a conductive layer defining a rectangular slot 312 overlapping with the L-shaped open-ended stubs, which establishes electromagnetic coupling wirelessly between the microstrip traces in the layer 302 and layer 304.

Prototypes were fabricated with (a) laser machining of a commercial microwave substrate material and (b) additive manufacturing of dielectric and conductive layers. As described herein, illustrative examples of such prototypes were manufactured and tested using excitation in the 8 GHz to 9 GHz band. In a first illustrative example that was experimentally evaluated, the dielectric material comprised Rogers 4003C (Rogers Corporation, Chandler, AZ, USA), with a relative dielectric permittivity of about 3.38, and a laminate thickness of 0.75 millimeters. The configuration included geometric parameters suitable for operation in a frequency range of 8 GHz to 9 GHz. Definitions for dimensions of the input and output transmission lines, open-ended stubs, and the coupling slot are shown below in TABLE I with reference to the labels shown in FIG. 3C. Such a configuration can be referred to as a Microstrip-Slot-Microstrip transition (MSM).

TABLE I
Dimensions used for Illustrative Examples Described Herein

| Variable | Value (mm) | Description |
|---|---|---|
| Offset | 6 | Distance from the slot's center to stub. |
| Lₛ | 12 | Length of Slot |
| Wₛ | 0.9 | Width of Slot |
| Lₘ | 8.9 | Length of Mircrostrip Stub |
| Wₘ | 1.8 | Width of Microstrip Line |
| d | 0.75 | Thickness of Dielectric layers |

Fabrication included processing of four copper-clad laminate sections of commercially available Rogers 4003C material using a 355 nanometer LPKF Protolaser U4 (LPKF Laser & Electronics, Tualatin, OR, USA), with the settings of 5.7 watts (W) for contour cutting and 4.1 W for rubout. The layers of commercial substrate were aligned and affixed to each other using small bolts through reference holes, allowing for rapid changes to single layers for ease of prototyping.

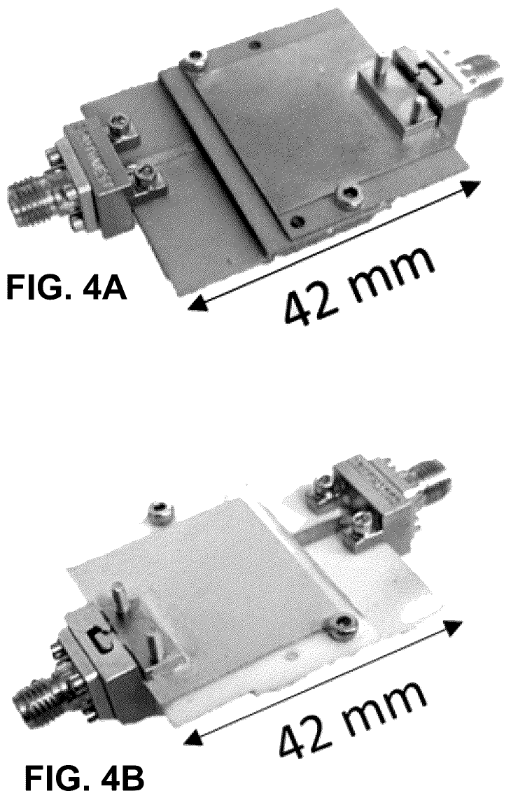

FIG. 4A shows an image of an illustrative example comprising a microstrip-slot-microstrip (MSM) transition comprising the configuration shown in FIG. 3A, FIG. 3B, and FIG. 3C, manufactured using a Rogers 4003C material. The assembled configuration with SMA (Sub-Miniature Version A) end-launch connectors is shown in FIG. 4A.

FIG. 4B shows an image of an illustrative example comprising a microstrip-slot-microstrip (MSM) transition comprising the configuration shown in FIG. 3A, FIG. 3B, and FIG. 3C, fabricated using an additive manufacturing approach. An additively manufactured prototype is shown in FIG. 4B. Dielectric layers were fabricated using fused deposition modeling (FDM) of acrylonitrile butadiene styrene (ABS) on an nScrypt3Dn (nScrypt, Orlando, Florida, USA) system by extruding at a temperature of 235° C. using a ceramic tip with an inner diameter of 150 micrometers (μm). The print layer thickness and speed were set to 100 μm and 20 millimeters per second (mm/s), respectively. The conductive layers were manufactured (e.g., patterned) by microdispensing Dupont CB028 (DuPont de Nemours, Inc., Wilmington, DE, USA), a silver-based conductive paste, with a pressure of 8.2 psi, a ceramic tip with inner diameter of 100 μm, and a printing height and speed of 100 μm and 10 mm/s, respectively. In both FIG. 4A and FIG. 4B, microwave SMA female end-launch connectors are used to transition from coaxial cables to the microstrip transmission line structures.

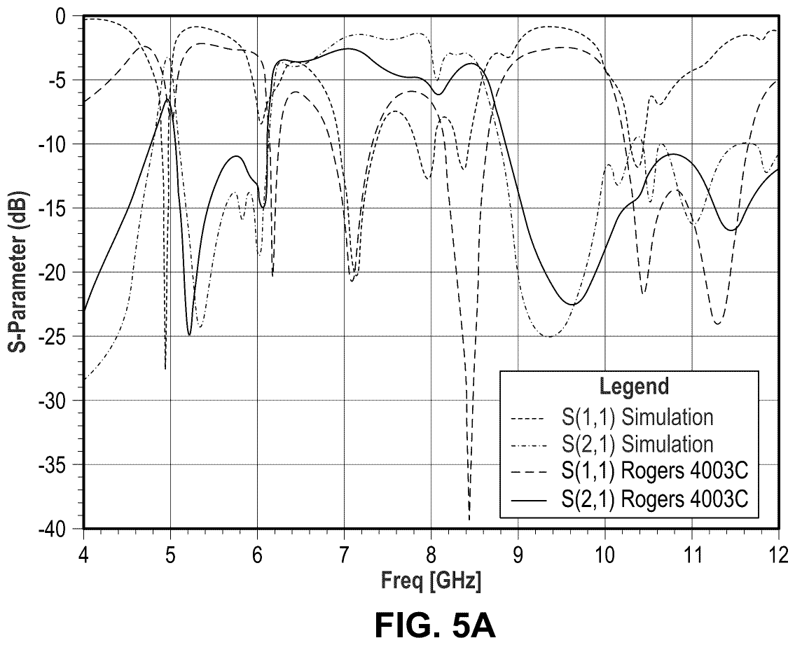

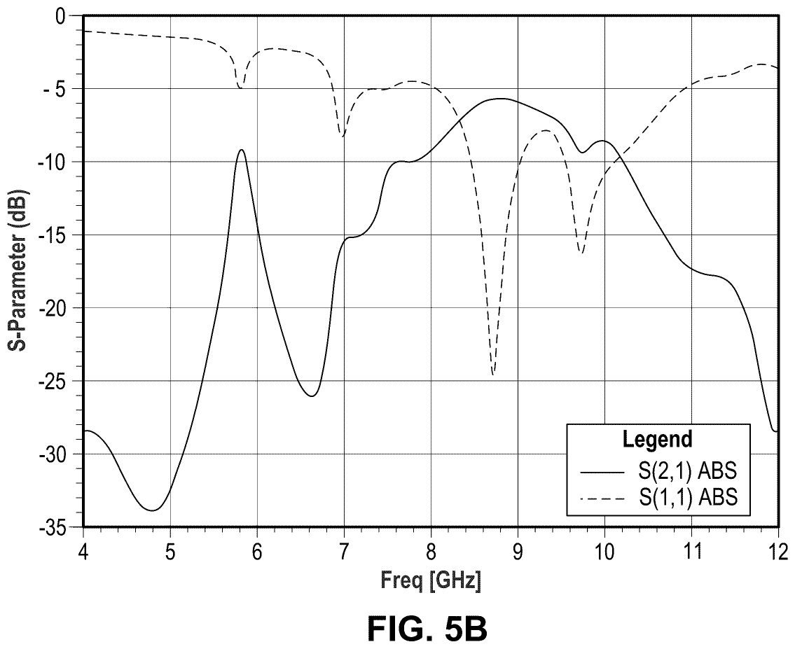

Ansys High-Frequency Structure Simulator (HFSS) (Ansys, Canonsburg, PA, USA) was used to evaluate structural parameters for a multilayer stack to establish electromagnetic coupling from one side of the structure to the other in a way that the layers can be detached from each other. For example, FIG. 5A shows S-Parameters as simulated and measured for the illustrative example shown in FIG. 4A fabricated using Rogers 4003C, and FIG. 5B shows S-Parameters simulated and measured for the example shown in FIG. 4B fabricated using the additive manufacturing approach.

In particular, FIG. 5A shows simulated and measured S-parameter values over a range of frequencies from 4 GHz to 12 GHz. The simulated S-parameter results for the Rogers 4003C configuration of FIG. 4A were obtained using the Ansys HFSS release 2021R02, by modeling the geometry shown in FIG. 3A, FIG. 3B, and FIG. 3C. The measured S-parameters for the Rogers 4003C prototype are also shown in FIG. 5A. The frequency band of operation for which the geometric parameters from TABLE I were selected was 8 GHz to 9 GHz, however, the coupling approach using this general structural configuration can also operate at other frequencies. The measured results were obtained using a Keysight E5071C ENA, calibrated with a Keysight N4433A ECal Kit, and measurements were made with Keysight 3.5 mm coaxial cables (Keysight Technologies, Santa Rosa, CA, USA).

The MSM coupling topology is compatible with applications where the antenna feed is to be detachable from the radiating antenna structure, and as discussed above, this configuration does not require a conductive electrical connection through one or more dielectric layers. Experimental results as shown in FIG. 5A and FIG. 5B illustrate that the Rogers 4003C assembly shows an insertion loss of around 3 dB at the 8.5 GHz center frequency, and a return loss greater than 35 dB. The 3 dB of loss can be associated with dissipative losses in the transmission line segments, and potential radiation losses. Referring to FIG. 5B, the additively manufactured example shows an insertion loss of around 5.5 dB at 8.65 GHZ, and a return loss greater than 20 dB at the same frequency. Differences between the Rogers 4003C and the additive manufacturing prototypes can be associated with (a) increased dissipative losses on the additively manufactured (e.g., printed) traces when compared with copper traces on the Rogers laminates, (b) differences in the predicted and actual permittivity of ABS, and (c) misalignment between the different layers.

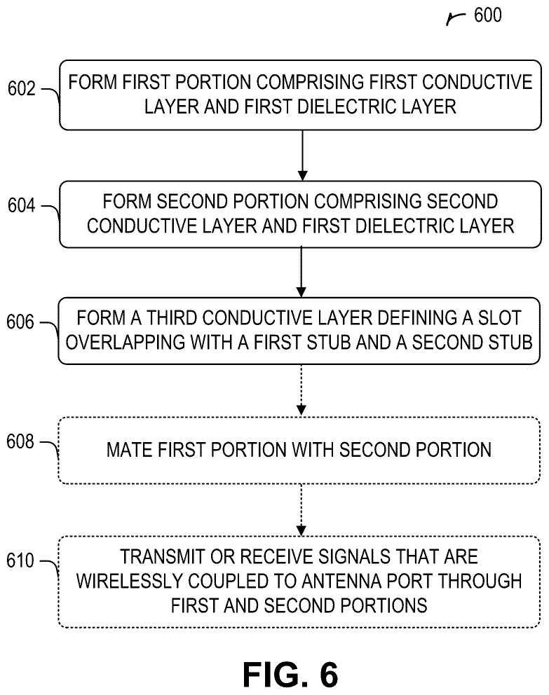

FIG. 6 shows an illustrative example of a technique 600, such as a method, for fabricating an electromagnetic coupling structure. The technique can include, at 602, forming a first portion comprising a first conductive layer and a first dielectric layer. At 604, a second portion comprising a second conductive layer and a second dielectric can be formed. For example, as discussed above, one or more of the first conductive layer, second conductive layer, first dielectric layer, or second dielectric layer can be formed using additive manufacturing (e.g., where a dielectric material is printed, dispensed, or molded, and one or more conductive layers are patterned by dispensing a conductive ink). In another approach, one or more conductive layers can be formed by laser machining or lithographically etching a conductive material that clads a dielectric material. At 606, the technique 600 can include forming a third conductive layer defining a slot overlapping with a first stub formed in the first conductive layer, and a second stub formed in the second conductive layer. The third conductive layer can be included as part of the first portion (e.g., a first sub-assembly) or the second portion (e.g., a second sub-assembly).

Optionally, at 608, the first portion can be mated with the second portion, such as shown and described elsewhere herein. At 610, optionally, when the first portion is attached to the second portion, a signal that is wirelessly coupled through the first and second portions can be transmitted (e.g., radiated) by an antenna structure, or the antenna structure can receive an incoming radiated signal and provide a signal to a port, where the signal is wirelessly coupled through the first and second portions. The wireless coupling is generally not performed by the antenna structure, but by interaction between transmission line structures formed in the first and second conductive layers, respectively, and by coupling facilitated by a slot structure as shown and described elsewhere herein.

In general, the present subject matter may provide one or more of the following aspects:

1. No holes are required extending all the way between the exterior/inner surface. Accordingly, a purely wireless signal transfer can occur between coupled layers.

2. Coupled layers can be mechanically detached from each other to provide detachability without requiring connection/disconnection of conductive electrical interconnections.

3. The coupling approach can be applied to other circuits, such as conformal electronic systems, not just antennas, and the planar examples described herein can be fabricated to be curved or conformal.

4. The approach described herein is compatible with additive manufacturing, such as for conformal fabrication of dielectric layers, conductive layers, or both, or “hybrid” approaches using additive manufacturing and non-additive manufacturing approaches.

5. The approach described herein is compatible with extreme/harsh environments.

6. The approach described herein can be used for a variety of different frequency ranges (e.g., the 8 GHz to 9 GHz “X Band” application described herein is an illustrative example, and other frequency ranges are compatible with the approach described herein).

7. The structure can include alignment features such as screw or tooling holes as shown in the prototypes described herein.

### Various Notes

Example 1 comprises an electronic assembly for wirelessly coupling a signal between transmission line structures, the electronic assembly comprising a first portion comprising a first conductive layer and a first dielectric layer, the first conductive layer defining a first stub, a second portion comprising a second conductive layer and a second dielectric layer, the second conductive layer defining a second stub, and a third conductive layer defining a slot overlapping with the first stub and the second stub.

In Example 2, the electronic assembly of Example 1 optionally includes that the first portion comprises a first reference plane layer and a first dielectric core layer, wherein the first conductive layer and the first reference plane layer clad the first dielectric core layer, and wherein the first dielectric layer is located on a surface of the first conductive layer opposite the first dielectric core layer.

In Example 3, the electronic assembly of Example 1 or Example 2 optionally includes that the first conductive layer and the first reference plane layer define a first microstrip transmission line structure terminating in the first stub.

In Example 4, the electronic assembly of Example 3 optionally includes that the second portion comprises a second reference plane layer and a second dielectric core layer, wherein the second conductive layer and the second reference plane layer clad the second dielectric core layer, and wherein the second dielectric layer is located on a surface of the second conductive layer opposite the second dielectric core layer.

In Example 5, the electronic assembly of Example 4 optionally includes that the second conductive layer and the second reference plane layer define a second microstrip transmission line structure terminating in the second stub.

In Example 6, the electronic assembly of any of Example 1 through Example 5 optionally includes that the second conductive layer comprises a radiating element or is coupled to a radiating element.

In Example 7, the electronic assembly of any of Example 1 through Example 6 optionally includes that the first dielectric layer comprises an interior or base portion of a structure, wherein the second dielectric layer comprises an exterior portion of a structure.

In Example 8, the electronic assembly of Example 7 optionally includes that the first portion including the interior or base portion of the structure is detachable from the second portion including the exterior portion.

In Example 9, the electronic assembly of any of Example 1 through Example 8 optionally includes that the second portion comprises a radome or airfoil structure.

In Example 10, the electronic assembly of any of Example 1 through Example 9 optionally includes that the first portion defines an input port.

In Example 11, the electronic assembly of Example 10 optionally includes that the second portion defines an output port.

Example 12 comprises an apparatus including an antenna and associated feed structure, the apparatus comprising an antenna port, a wireless electromagnetic coupling structure comprising a line-slot-line transition to couple a signal from or to the antenna port wirelessly through a conductive layer comprising a slot, and a radiating element configured to radiate the signal that is wirelessly coupled through the slot, or to receive incoming radiated energy and provide the signal that is wirelessly coupled through the slot as a received signal.

In Example 13, the apparatus of Example 12 optionally includes that the line-slot-line transition comprises a dielectric material or is coupled to a dielectric material defining a radome.

In Example 14, the apparatus of Example 13 optionally includes that the antenna port is located within an interior of the radome.

In Example 15, the apparatus of Example 13 or Example 14 optionally includes

that the radiating element is located on an exterior of the radome or within the dielectric material defining the radome.

In Example 16, the apparatus of Example 15 optionally includes that at least one of the radiating element or the wireless electromagnetic coupling structure is conformal to a shape of the radome.

Example 17 comprises a method for fabricating an electronic assembly for wirelessly coupling a signal between transmission line structures, the method comprising forming a first portion comprising at a first conductive layer and a first dielectric layer, the first conductive layer defining a first stub, forming a second portion comprising a second conductive layer and a second dielectric layer, the second conductive layer defining a a second stub, and forming a third conductive layer defining a slot overlapping with the first stub and the second stub.

In Example 18, the method of Example 17 optionally includes at least one of patterning a conductive material defining the first conductive layer upon the first dielectric layer or patterning a conductive material defining the second conductive layer upon the second dielectric layer.

In Example 19, the method of Example 18 optionally includes at least one of additively manufacturing the first dielectric layer or the second dielectric layer.

In Example 20, the method of any of Example 17 through Example 19 optionally includes that at least one of the first portion or the second portion comprises a portion of a radome including a radiating element.

Each of the non-limiting Examples above can stand on its own or can be combined in various permutations or combinations with one or more of the other Examples or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An electronic assembly for wirelessly coupling a signal between transmission line structures, the electronic assembly comprising:
a first portion comprising a first conductive layer and a first dielectric layer, the first conductive layer defining a first stub;
a second portion comprising a second conductive layer and a second dielectric layer, the second conductive layer defining a second stub; and
a third conductive layer defining a slot overlapping with the first stub and the second stub.

2. The electronic assembly of claim 1, wherein the first portion comprises a first reference plane layer and a first dielectric core layer;
wherein the first conductive layer and the first reference plane layer clad the first dielectric core layer; and
wherein the first dielectric layer is located on a surface of the first conductive layer opposite the first dielectric core layer.

3. The electronic assembly of claim 2, wherein the first conductive layer and the first reference plane layer define a first microstrip transmission line structure terminating in the first stub.

4. The electronic assembly of claim 3, wherein the second portion comprises a second reference plane layer and a second dielectric core layer;
wherein the second conductive layer and the second reference plane layer clad the second dielectric core layer; and
wherein the second dielectric layer is located on a surface of the second conductive layer opposite the second dielectric core layer.

5. The electronic assembly of claim 4, wherein the second conductive layer and the second reference plane layer define a second microstrip transmission line structure terminating in the second stub.

6. The electronic assembly of claim 1, wherein the second conductive layer comprises a radiating element or is coupled to a radiating element.

7. The electronic assembly of claim 1, wherein the first dielectric layer comprises an interior or base portion of a structure; and
wherein the second dielectric layer comprises an exterior portion of a structure.

8. The electronic assembly of claim 7, wherein the first portion including the interior or base portion of the structure is detachable from the second portion including the exterior portion.

9. The electronic assembly of claim 1, wherein the second portion comprises a radome or airfoil structure.

10. The electronic assembly of claim 1, wherein the first portion defines an input port.

11. The electronic assembly of claim 10, wherein the second portion defines an output port.

12. An antenna and feed structure, comprising:
an antenna port;
a wireless electromagnetic coupling structure comprising a line-slot-line transition to couple a signal from or to the antenna port wirelessly through a conductive layer comprising a slot; and
a radiating element configured to radiate the signal that is wirelessly coupled through the slot, or to receive incoming radiated energy and provide the signal that is wirelessly coupled through the slot as a received signal.

13. The antenna and feed structure of claim 12, wherein the line-slot-line transition comprises a dielectric material or is coupled to a dielectric material defining a radome.

14. The antenna and feed structure of claim 13, wherein the antenna port is located within an interior of the radome.

15. The antenna and feed structure of claim 13, wherein the radiating element is located on an exterior of the radome or within the dielectric material defining the radome.

16. The antenna and feed structure of claim 15, wherein at least one of the radiating element or the wireless electromagnetic coupling structure is conformal to a shape of the radome.

17. A method for fabricating an electronic assembly for wirelessly coupling a signal between transmission line structures, the method comprising:
forming a first portion comprising at a first conductive layer and a first dielectric layer, the first conductive layer defining a first stub; and
forming a second portion comprising a second conductive layer and a second dielectric layer, the second conductive layer defining a a second stub; and
forming a third conductive layer defining a slot overlapping with the first stub and the second stub.

18. The method of claim 17, comprising at least one of patterning a conductive material defining the first conductive layer upon the first dielectric layer or patterning a conductive material defining the second conductive layer upon the second dielectric layer.

19. The method of claim 18, comprising at least one of additively manufacturing the first dielectric layer or the second dielectric layer.

20. The method of claim 17, wherein at least one of the first portion or the second portion comprises a portion of a radome including a radiating element.
